(19) United States
(12) Patent Application Publication
(10) Pub. No.: US 2014/0184318 A1
(43) Pub. Date: Jul. 3, 2014

(54) POWER SUPPLY CIRCUITRY

(71) Applicant: Dolphin Integration, Meylan (FR)

(72) Inventors: Loïc Sibeud, Grenoble (FR); Grégoire Gimenez, Eybens (FR)

(73) Assignee: Dolphin Integration, Meylan (FR)

(21) Appl. No.: 14/141,369

(22) Filed: Dec. 26, 2013

(30) Foreign Application Priority Data
Dec. 27, 2012 (FR) 1262871

(51) Int. Cl. G05F 1/46

(52) U.S. Cl. CPC G05F 1/468
USPC 327/543

(57) ABSTRACT

The invention concerns power supply circuitry for controlling a power-up phase of an islet of an integrated circuit, the circuitry having: a switch (102) controlled by a current and coupled between a supply voltage rail (104) and an internal voltage rail (105) of the islet.

### FIELD

The present disclosure relates to power supply circuitry and to a method for controlling a power-up phase of a circuit region of an integrated circuit.

### BACKGROUND

In order to lower the power consumption of integrated circuits, it has been proposed to allow certain regions of an integrated circuit to power-down while not in use. This involves disconnecting these circuit regions, often referred to as islets, from the supply voltage of the integrated circuit.

A problem that occurs during power-up of the islet is that a high transient current may be drawn, leading to a voltage bounce, in other words a voltage drop followed by a voltage rise, on the supply voltage rail of the integrated circuit. Such a voltage bounce should be controlled in order to keep the supply voltage within its specified range.

Solutions have been proposed for limiting the current supplied during power-up of an islet. However, existing solutions tend to be complex, and/or result in an undesirable time delay in the power-up of an islet. There is thus a need for an improved circuit and method for controlling the power-up phase of one or more islets of an integrated circuit.

### SUMMARY

It is an aim of the embodiments described herein to at least partially address one or more needs in the prior art.

According to one aspect, there is provided power supply circuitry for controlling a power-up phase of an islet of an integrated circuit, the circuitry comprising: a switch controlled by a current and coupled between a supply voltage rail and an internal voltage rail of said islet.

According to an embodiment, the reference current is variable, and the power supply circuitry further comprises a generation circuit adapted to generate the variable reference current.

According to an embodiment, the current-controlled switch is adapted to operate, during said power-up phase, in a current-limited mode in which the current supplied by the switch is limited based on a reference current, and to operate, at the end of said power-up phase, in a non-limited-current mode in which the current supplied by the switch is not limited based on said reference current.

According to an embodiment, the power supply circuitry further comprises a control circuit adapted to supply a feedback signal to said current-controlled switch, the switch being adapted to change from said current-limited mode to the non-limited-current mode based on the feedback signal.

According to an embodiment, the current-controlled switch comprises: a first transistor coupled by its main current nodes between said supply voltage rail and the internal voltage rail; and second and third transistors coupled in series by their main current nodes between said supply voltage rail and an input line for receiving said reference current, wherein control nodes of said first and second transistors are coupled to said input line, and a control node of said third transistor is adapted to receive said feedback signal.

According to an embodiment, the control circuit comprises an amplifier adapted to generate the feedback signal based on a comparison between the voltage level of said internal voltage rail and the voltage level at a node between the second and third transistors of the current-controlled switch.

According to an embodiment, the control circuit is adapted to generate the feedback signal based on a detected level of the voltage on the internal voltage rail.

According to an embodiment, the control circuit is adapted to generate the feedback signal based on a detected rate-of-change or slope of the voltage on the internal rail.

According to an embodiment, the control circuit is adapted to generate the feedback signal based on a detected level of the voltage on the supply voltage rail.

According to a further aspect, there is provided an integrated circuit comprising: at least one islet comprising the above power supply circuit; and a control unit adapted to selectively activate the power supply circuit of the at least one islet.

According to yet a further aspect, there is provided a method of controlling a power-up phase of an islet of an integrated circuit, the islet comprising a current-controlled switch coupled between a supply voltage rail and an internal voltage rail of the islet, the method comprising: during the power-up phase, controlling the current-controlled switch to operate in a current-limited mode in which the current supplied by the switch is limited based on a reference current.

According to an embodiment, the method further comprises, at the end of the power-up phase, controlling the current-controlled switch to operate in a non-limited-current mode in which the current supplied by the switch is not limited based on the reference current.

According to one embodiment, the current-controlled switch comprises a first transistor coupled by its main current nodes between the supply voltage rail and the internal voltage rail; and second and third transistors coupled in series by their main current nodes between the supply voltage rail and an input line for receiving the reference current, control nodes of the first and second transistors being coupled to the input line, and a control node of the third transistor being adapted to receive a feedback signal, and wherein controlling the current-controlled switch to operate in the current-limited mode comprises driving the feedback signal to activate the third transistor; and controlling the current-controlled switch to operate in non-limited-current mode comprises driving the feedback signal to deactivate the third transistor.

According to an embodiment, controlling the current-controlled switch to operate in the non-limited-current mode comprises detecting, by a control circuit, when the voltage on the internal voltage rail reaches a set level.

According to an embodiment, controlling the current-controlled switch to operate in the non-limited-current mode comprises detecting, by a control circuit, when the time derivative of the voltage on the internal voltage rail drops below a set level during the power-up phase.

### BRIEF DESCRIPTION OF THE DRAWINGS

The foregoing and other purposes, features, aspects and advantages of the invention will become apparent from the following detailed description of embodiments, given by way of illustration and not limitation with reference to the accompanying drawings, in which:

FIG. 1A illustrates an islet of an integrated circuit according to an example embodiment;

FIG. 1B illustrates timing signals in the islet of FIG. 1A according to an example embodiment;

FIG. 2 illustrates a current-controlled switch of the islet of FIG. 1A in more detail according to an example embodiment;

FIGS. 3A and 3B illustrate a reference current generation circuit of the islet of FIG. 1A according to example embodiments;

FIG. 3C illustrates the reference current generation circuit according to an alternative embodiment;

FIGS. 4A to 4C illustrate circuitry of a controller of FIG. 1A for generating a feedback signal according to example embodiments;

FIG. 5 illustrates an integrated circuit according to an example embodiment; and

FIG. 6 illustrates timing signals in the integrated circuit of FIG. 5 according to an example embodiment.

Throughout the drawings, like reference numerals are used to designate like features.

### DETAILED DESCRIPTION

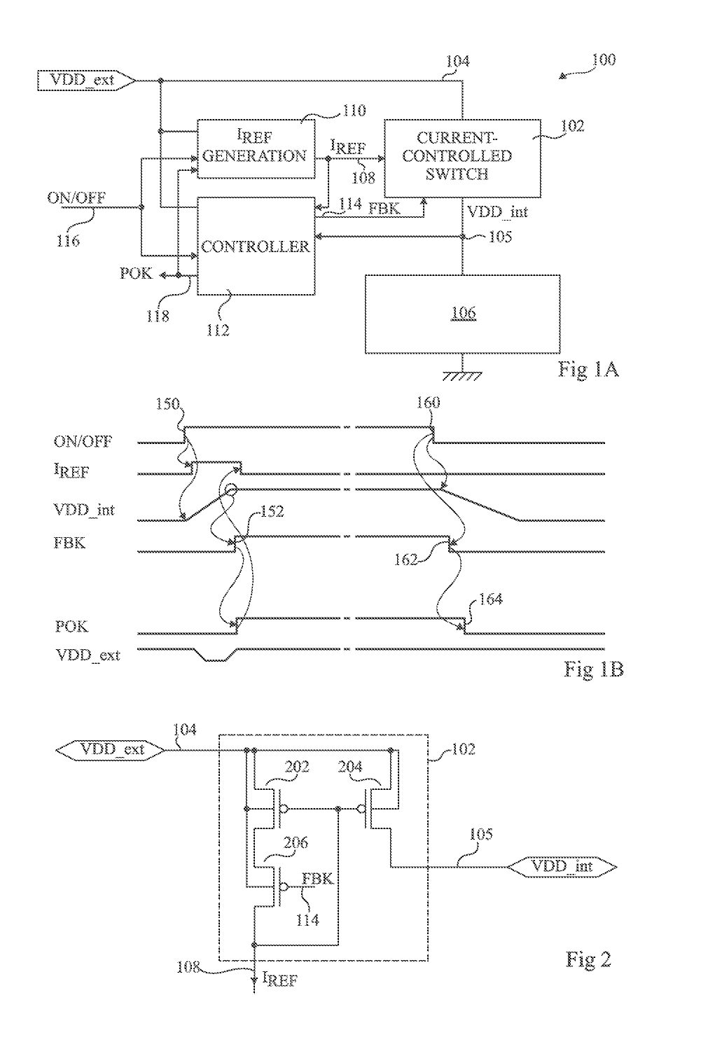

FIG. 1A illustrates the islet 100 according to an example embodiment. As illustrated, the islet 100 for example comprises a current-controlled switch 102, coupled between a supply voltage rail 104 supplying the supply voltage VDD_ext and an internal supply rail 105 supplying an internal supply voltage VDD_int to functional circuitry 106 of the islet 100. Switch 102 is controlled by a reference current I_{REF}, which is for example provided on a line 108 from a generation circuit (I_{REF} GENERATION) 110.

The internal supply voltage VDD_int is also for example provided to a controller 112, which provides a feedback signal FBK to the current-controlled switch 102 on a line 114 based on information sensed from voltage VDD_int. The feedback signal FBK for example switches the switch 102 between a limited-current mode, in which the current supplied by the switch on the internal supply rail 105 is limited based on the reference current I_{REF}, and a non-limited-current mode, in which the current supplied by the switch 102 is not limited based on the reference current I_{REF}. The controller 112 and the generation circuit 110 each for example receive the activation signal ON/OFF on a line 116. The controller 112 for example provides the acknowledgement signal POK on line 118, which is for example provided to the generation circuit 110.

FIG. 1B is a timing diagram showing examples of the timing of the signals ON/OFF, I_{REF}, VDD_int, FBK, POK and VDD_ext in the circuitry of FIG. 1A during a power-up phase followed by a power-down phase.

Upon assertion of the activation signal ON/OFF shown by a rising edge 150, which starts a power-up phase of islet 100, the reference current I_{REF} is triggered, and the feedback signal FBK is for example already low, meaning that the switch 102 is in the limited-current mode. The internal voltage level VDD_int on the voltage rail 105 thus starts to rise, for example in a relatively linear manner. During the power-up phase, a small IR drop is for example seen on the supply voltage VDD_ext, but as will be described in more detail below, the level of the reference current I_{REF} is for example chosen such that the supply voltage VDD_ext does not fall below a certain level, for example not less than 90 percent of its normal level.

The controller 112 detects when the internal voltage level VDD_int has reached a level at or close to its normal operating level, and then asserts the feedback signal FBK, as shown by a rising edge 152. This for example switches the switch 102 to the non-limited-current mode and thereby reduces the static power consumption of the I_{REF} generation circuit 110. The signal POK is then brought high in response to the rising feedback signal FBK, and in response the reference current I_{REF} for example goes low.

When the islet 100 is to be powered down, the activations signal ON/OFF is brought low, as shown by a falling edge 160 in FIG. 1B. A short time delay later, the controller 112 for example turns off the current controlled switch 102 thereby disconnecting the supply voltage VDD_int on rail 105 from the supply voltage VDD_ext on rail 104. Furthermore, the controller 112 for example brings low the feedback signal FBK, as shown by a falling edge 162, and the acknowledgement signal POK is brought low by a falling edge 164 a short time later. As illustrated in FIG. 1B, the supply voltage VDD_int then for example falls slowly to a ground value as a result of current leakage. In alternative embodiments, the voltage could be pulled down by a dedicated transistor.

FIG. 2 illustrates an example of a circuit implementing the current-controlled switch 102 of FIG. 1A.

As illustrated in FIG. 2, the supply voltage rail 104 is coupled to the source of a p-channel MOS (PMOS) transistor 202, and to the source of a PMOS transistor 204. The drain of transistor 202 is coupled via the main current nodes of a PMOS transistor 206 to line 108 on which the current reference I_{REF} is provided. The gates of transistors 202 and 204 are coupled together and to line 108. The gate of transistor 206 receives the feedback signal FBK on line 114 from the controller 112. The drain of transistor 204 is coupled to the internal supply rail 105. The bulks of transistors 202, 204 and 206 are all for example coupled to the supply rail 104.

In operation, when the feedback signal FBK is low, the transistor 206 conducts the current I_{REF}, and the transistors 202 and 204 form a current mirror resulting in transistor 204 conducting a current that is proportional to, and thus limited by, the current I_{REF}. Thus a low state of the feedback signal FBK corresponds to a limited-current mode of the current-controlled switch 102. The dimensions of transistor 204 could be equal to those of transistor 202, in which case the current conducted by transistor 204 will be limited to the reference current I_{REF}. Alternatively, transistor 204 could be of much greater dimensions than transistor 202, for example between 20 and 1000 times the size of transistor 202, such that its current is limited to a level between 20 and 1000 times the current I_{REF}.

When the feedback signal FBK is high, transistor 206 is non-conducting, and thus the transistor 204 will be in a conducting state in which the current it supplies is no longer limited by the reference current I_{REF}. Thus a high state of the feedback signal FBK corresponds to the non-limited current mode of the switch 102.

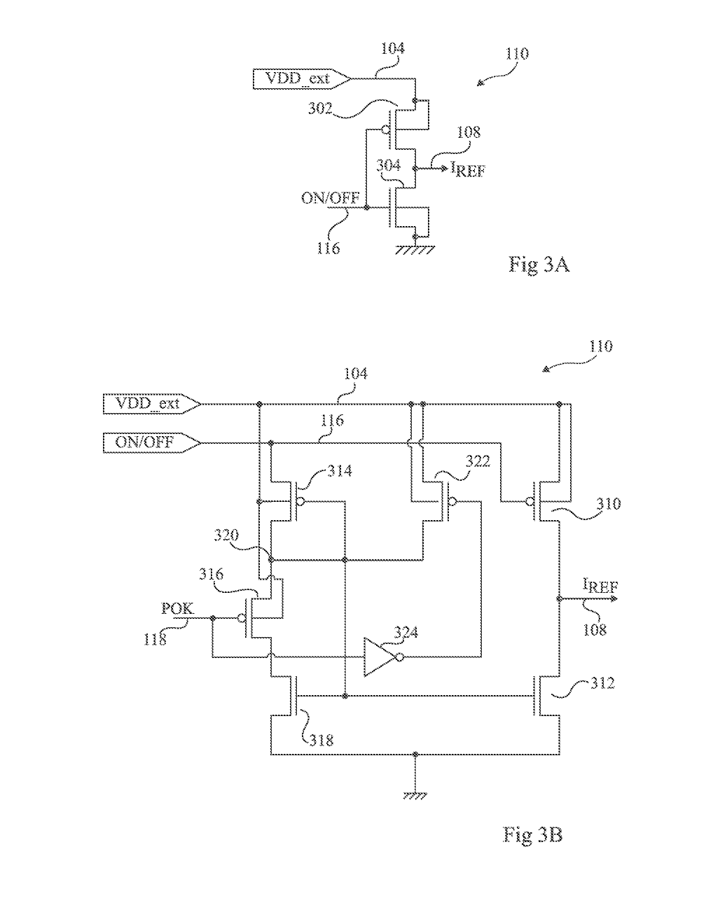

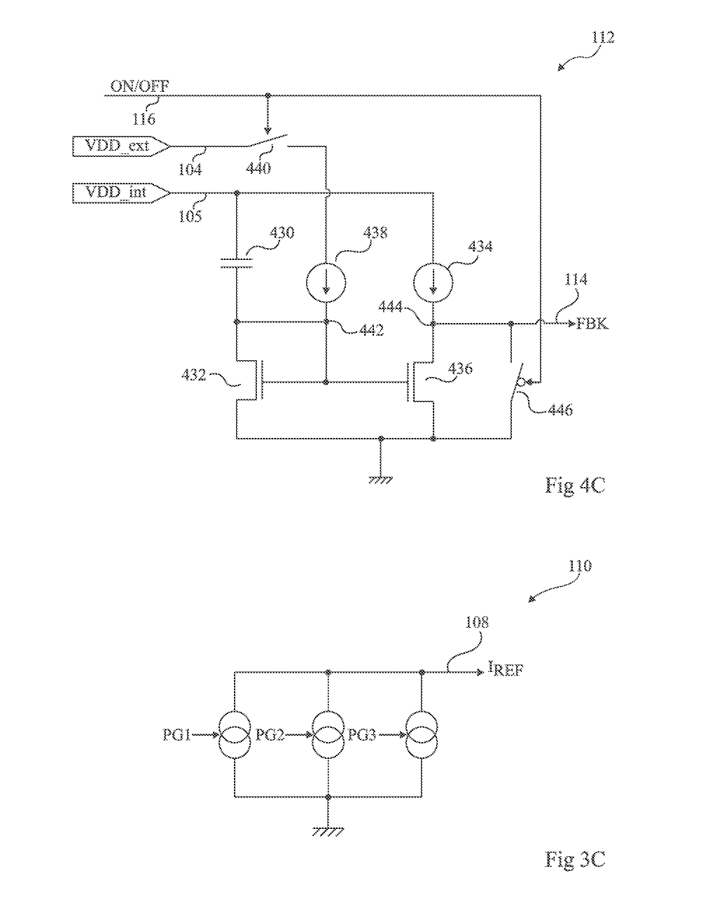

FIG. 3A illustrates the reference current generation circuit 110 according to one example in which it comprises a p-channel MOS (PMOS) transistor 302 and n-channel MOS (NMOS) transistor 304 coupled in series by their main current nodes between the supply voltage rail 104 and ground. The gates of transistors 302 and 304 are controlled by the activation signal ON/OFF on line 116, such that the reference current is generated whenever the signal ON/OFF is high. The value of the reference current is for example set by the dimensions of transistor 304, and by the dimensions of transistors 202 and 206 of the switch 102.

FIG. 3B illustrates the reference current generation circuit 110 according to an alternative example to that of FIG. 3A. In the embodiment of FIG. 3B, a PMOS transistor 310 and an NMOS transistor 312 are coupled in series by their main current nodes between the supply voltage rail 104 and ground. Furthermore, a PMOS transistor 314, a PMOS transistor 316 and an NMOS transistor 318 are coupled in series by their main current nodes between the line 116, providing the signal ON/OFF and ground. A node 320 between PMOS transistors 314 and 316 is coupled to the gate of PMOS transistor 314, and to the gates of NMOS transistors 312 and 318. Furthermore, node 320 is coupled to the supply voltage rail 104 via the main current nodes of a PMOS transistor 322. The gate of PMOS transistor 316 receives the acknowledgement signal POK on line 118, while the gate of PMOS transistor 322 receives this signal after it has been inverted by an inverter 324. The gate of PMOS transistor 310 receives the ON/OFF signal on line 116. All of the PMOS transistors 310, 314, 316 and 322 for example have their bulk connections coupled to the supply voltage rail 104.

In operation, when the activation signal ON/OFF on line 116 is asserted and the acknowledgement signal POK is low, the current I_{REF} will be proportional to the current conducted by the transistors 314, 316 and 318. However, the current I_{REF} will fall to zero if the signal POK goes high or if the signal ON/OFF falls low. Transistor 322 enables the gate of transistor 312 to be driven with relatively low impedance when the signal POK is high.

FIG. 3C illustrates the reference current generation circuit 110 according to an alternative example to that of FIGS. 3A and 3B, in which the reference current can be set at zero, or at one of a plurality of further current levels. For this, a plurality of current sources, for example three, are coupled in parallel between the line 108 and ground. Each of these current sources can be activated or deactivated by a respective control signal, labelled PG1 to PG3 in the example of FIG. 3C. The reference current I_{REF} is equal to the sum of the currents generated by each of the activated current sources. Each of the current sources, when activated, for example generates the same current level. However, in alternative embodiments, the current sources could have different sizes and thus generate different levels of current from each other. The control signals for controlling the current sources may be set at fixed values for a given islet to be powered. Alternatively, the control signals may be adapted during the power-up of an islet, for example such that the current mirrors are turned-on one by one to progressively increase the reference current.

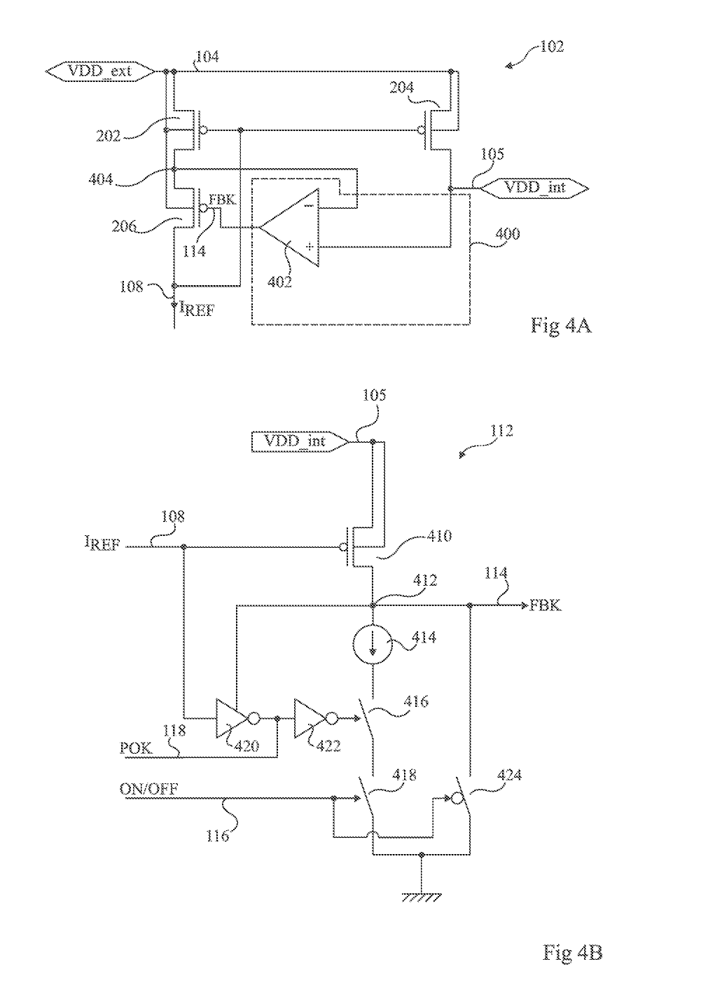

FIG. 4A illustrates the current-controlled switch 102 of FIG. 2, which is the same as that of FIG. 2, and will not be described again in detail. FIG. 4A additionally illustrates circuitry 400 forming part of the controller 112 for generating the feedback signal FBK according to an example embodiment in which the current limit is removed using the feedback loop to bring the drain voltages of transistors 402 and 404 of the current-controlled switch to a same value.

The circuitry 400 for example comprises an amplifier 402 having a negative input coupled to a node 404 between the PMOS transistors 202 and 206 of the current-controlled switch 102, and a positive input coupled to the internal supply rail 105. The output of amplifier 402 provides the feedback signal FBK on line 114 to the gate of PMOS transistor 206.

In operation, amplifier 402 drives the gate of transistor 206 to bring the voltage at node 404 to the voltage on the internal voltage rail 105, in order to impose identical current densities through transistors 202 and 204 when the voltage level of VDD_int on rail 105 gets close to the level of VDD_ext. As no DC current is drawn from the supply rail 105 until the acknowledgement signal POK goes high, the supply rail 105 will for example reach the level of voltage VDD_ext, whereas node 404 will always remain below the level of voltage VDD_ext due to the current I_{REF} flowing through transistor 202. This dissymmetry advantageously results in the feedback signal FBK converging to a high level in which transistor 206 is no longer conducting.

FIG. 4B illustrates an example of the circuitry forming the controller 112 for generating the feedback signal FBK according to an alternative embodiment in which the feedback signal is generated based on the level of the supply voltage VDD_int.

As illustrated, the circuitry 112 for example comprises a PMOS transistor 410 coupled by its main current nodes between the VDD_int supply rail 105 and a node 412. Node 412 is further coupled to a current sink 414, which is in turn coupled to ground via the series connection of a switch 416 and a switch 418. The gate of PMOS transistor 410 is coupled to the line 108 on which the reference current I_{REF} is provided to the current-controlled switch 102. Furthermore, line 108 controls, via the series connection of two inverters 420 and 422, the switch 416. Inverter 420 has its voltage supply input coupled to node 412. The ON/OFF signal on line 116 controls the switch 418 and also the inverse input of a further switch 424 coupled between node 412 and ground. Node 412 provides the feedback signal FBK on line 114. A node between the inverters 420 and 422 provides the signal POK on line 118.

In operation, the current sink 414 is activated when the signal ON/OFF is high and the voltage on line 108 is high, such that the signal POK is low. The current sink 414 is deactivated when the signal ON/OFF is low or the voltage on line 108 is low, such that signal POK is high. Switch 424 brings the feedback signal FBK low while the ON/OFF signal on line 116 is low, thereby ensuring that the switch is in the current-limited mode prior to initiating a power up phase of the islet. Current sink 414 will maintain the signal FBK in the low state as long as the internal supply voltage VDD_int on line 105 has not become high enough to turn on transistor 410 and bring the signal FBK high, thereby removing the current limit in the current-controlled switch 102. The level of current conducted by the current sink 414 and the size of the transistor 410 are for example chosen such that the feedback signal FBK is asserted when the voltage level of VDD_int reaches the level of VDD_ext.

FIG. 4C illustrates an example of the circuitry forming the controller 112 for generating the feedback signal FBK according to an alternative embodiment, according to which the current-limit of the current-controlled switch 102 is removed based on a detected slope of the voltage VDD_int on rail 105.

As illustrated, in this example, a capacitor 430 is coupled in series with an NMOS transistor 432 between the internal supply rail 105 and ground. A current source 434 and a further NMOS transistor 436 are also coupled in series between the voltage rail 105 and ground. A further current source 438 is coupled in series with a switch 440 between the supply voltage rail 104 and a node 442. Node 442 is coupled to the gates of transistors 432 and 436, and also to the drain of transistor 432. A node 444 between the current source 434 and the transistor 436 provides the feedback signal FBK on line 114, and is also coupled to ground via a switch 446. The signal ON/OFF on line 116 is coupled to the control input of the switch 440 and also to an inverse control input of switch 446.

In operation, the current sources 434 and 438 are for example chosen such that each provides a relatively low current, for example of between 1 μA and 1 mA, and the current provided by current source 434 is higher than the current provided by current source 438. As the voltage VDD_int starts at ground, when the signal ON/OFF goes high, the current source 434 is activated after the current source 438, thereby ensuring that the feedback signal FBK does not start in a high state. While the internal supply voltage VDD_int on rail 105 is increasing, a current will flow through capacitor 620, thereby increasing the voltage on the gate of transistors 432 and 436, and thus pulling the feedback signal FBK to ground. When the voltage level VDD_int stabilizes as it approaches the level of supply voltage VDD_ext, the current flowing through capacitor 430 will drop, thereby lowing the gate voltage of transistors 432 and 436. As a consequence, the feedback signal FBK will rise towards the level of voltage VDD_int, thereby removing the current limitation imposed by the current-controlled switch 102.

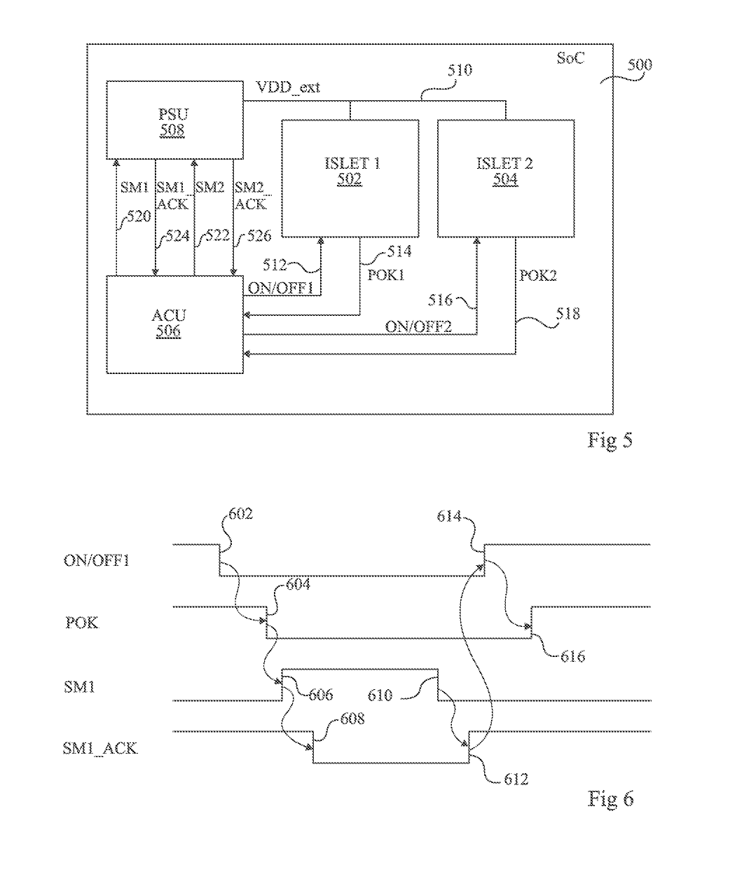

FIG. 5 illustrates an integrated circuit 500, which is for example a system on chip (SoC), and provides an example of a system in which the islet 100 of FIG. 1A can be integrated. SoC 500 for example forms part of an electronic device such as a personal computer, laptop computer, set-top box, or a portable device such a mobile telephone, digital camera, portable games console, global positioning device, etc.

In the example of FIG. 5, SoC 500 comprises an islet 502 (ISLET1) and an islet 504 (ISLET2). While two islets have been represented, in alternative embodiments just one or more than two islets could be present. Each of these islets for example comprises the circuitry of FIG. 1A described above.

SoC 500 for example comprises an activity control unit (ACU) 506 coupled to each of the islets 502 and 504. ACU 506 is also coupled to a power supply unit (PSU) 508, which provides a DC supply voltage VDD_ext to the islets 502 and 504 via a supply voltage rail 510, which for example corresponds to rail 104 of FIG. 1A. The PSU 508 for example comprises a DC to DC converter, entirely or partially integrated on chip.

ACU 506 provides an activation signal ON/OFF1 on a line 512 to islet 502, and receives from islet 502 an acknowledgement signal POK1 on a line 514 when a power-up phase of islet 502 has been completed. In a similar fashion, ACU 506 provides an activation signal ON/OFF2 on line 516 to the islet 504, and receives from the islet 504 an acknowledgement signal POK2 on a line 518 when the power-up phase of islet 504 has been completed.

ACU 506 also for example provides sleep mode signals SM1 and SM2 relating to islet 502 and islet 504 respectively to PSU 508 on respective lines 520 and 522. PSU 508 provides corresponding acknowledgement signals SM1_ACK and SM2_ACK on lines 524 and 526 respectively back to ACU 506.

An example of the operation of the circuitry of FIG. 5 will now be described with reference to the timing diagrams of FIG. 6.

The timing diagrams of FIG. 6 show an example of the timing signals ON/OFF1, POK1, SM1 and SM1_ACK, which relate to islet 502 of FIG. 5. A similar sequence of timing signals can be used to activate or deactivate other islets of the circuit of FIG. 5.

The activation signal ON/OFF1 is for example high when the islet 502 is active, and operating normally. When it is desired that islet 502 is powered-down, signal ON/OFF1 is brought low, as shown by edge 602 in FIG. 6. Control circuitry within islet 502 responds accordingly, by disconnecting the islet 502 from the supply voltage rail 510. Once power-down is completed, the acknowledgement signal POK1 on line 514 is for example brought low by the islet 502, as shown by falling edge 604.

When the acknowledgement signal POK1 is received by the ACU 506, the ACU 506 asserts the sleep mode signal SM1 on line 520 to the PSU 508, as shown by rising edge 606 in FIG. 6. This signal indicates to the PSU 508 that islet 502 has entered the sleep mode. In response, the PSU 508 may for example adapt its supply circuitry to the updated requirements. In particular, due to the reduced consumption of islet 502, parts of the PSU 508 may be deactivated to save power.

PSU 508 acknowledges the sleep mode of islet 502 by providing the acknowledgement signal SM1_ACK, in the example of FIG. 6 indicated by a falling edge 608 of this signal.

At the end of the sleep mode, when the islet 502 is to be reactivated, the ACU 506 first brings low the sleep mode signal SM1, as shown by edge 610 in FIG. 6. This forewarns the PSU 508 that islet 502 will be powered again, and PSU 508 for example responds by activating additional circuitry to meet the anticipated extra power requirements of islet 502. PSU 508 then acknowledges the intended end of the sleep mode of islet 502, by asserting the acknowledgement signal SM1_ACK, as shown by rising edge 612 in FIG. 6.

The ACU 506 then asserts the activation signal ON/OFF1 to islet 502, as represented by the rising edge 614, indicating to islet 502 that it is to be reactivated. Control circuitry in islet 502 responds by reconnecting the islet to the supply voltage rail 510 via a current-controlled switch, and then once the power-up phase of the islet 502 has been completed, the acknowledgement signal POK1 on line 514 is asserted, as shown by rising edge 616.

An advantage of the embodiments described herein is that, by providing both a current-controlled switch for supplying a limited current to an islet of an integrated circuit based on a reference current, and also a controller for removing this current limitation at the end of a power-up phase, the power-up of a relatively large islet can be achieved in a relatively fast and efficient manner, without inducing significant ripple on the supply voltage rail (VDD_ext), that could otherwise disturb other circuits of the SoC. The circuit of FIG. 2 provides a particularly simple and efficient implementation of the current-controlled switch.

Furthermore, advantageously the reference current I_{REF} and/or feedback signal FBK is based on the voltage level present on the external or internal supply rail.

Having thus described at least one illustrative embodiment of the invention, various alterations, modifications and improvements will readily occur to those skilled in the art.

For example, while the transistor supplying the current between the external voltage rail 104 and the internal voltage rail 105 has been represented in the drawings by a single transistor 204, it will be apparent to those skilled in the art that it could be formed of multiple transistors coupled in parallel, having common source, drain and gate nodes. The same could be true of any of the other transistors of the various circuits that have been illustrated.

Furthermore, it will be apparent to those skilled in that art that one or more of the PMOS transistors represented in the various circuits could be replaced by NMOS transistors in alternative implementations, or vice versa. Furthermore, while the transistors are described as MOS transistors, alternative technologies could be used.

Furthermore, it will be apparent to those skilled in the art that the ground connection indicated in the various embodiments could more generally be replaced by a VSS voltage at a level different from zero volts, and that the supply voltage level could be at zero volts or another level.

Furthermore, it will be apparent to those skilled in the art that the various circuits described in relation to the various figures could be combined in any combination.

1. Power supply circuitry for controlling a power-up phase of an islet of an integrated circuit, the circuitry comprising:
a switch controlled by a current and coupled between a supply voltage rail and an internal voltage rail of said islet.

2. The power supply circuitry of claim 1, wherein the current-controlled switch is adapted to operate, during said power-up phase, in a current-limited mode in which the current supplied by the switch is limited based on a reference current, and to operate, at the end of said power-up phase, in a non-limited-current mode in which the current supplied by the switch is not limited based on said reference current.

3. The power supply circuitry of claim 2, wherein said reference current is variable, the power supply circuitry further comprising a generation circuit adapted to generate the variable reference current.

4. The power supply circuitry of claim 2, further comprising:
a control circuit adapted to supply a feedback signal to said current-controlled switch, the switch being adapted to change from said current-limited mode to said non-limited-current mode based on said feedback signal.

5. The power supply circuitry of claim 4, wherein said current-controlled switch comprises:
a first transistor coupled by its main current nodes between said supply voltage rail and said internal voltage rail; and
second and third transistors coupled in series by their main current nodes between said supply voltage rail and an input line for receiving said reference current, wherein control nodes of said first and second transistors are coupled to said input line, and a control node of said third transistor is adapted to receive said feedback signal.

6. The power supply circuitry of claim 5, wherein said control circuit comprises an amplifier adapted to generate said feedback signal based on a comparison between the voltage level of said internal voltage rail and the voltage level at a node between said second and third transistors of said current-controlled switch.

7. The power supply circuitry of claim 4, wherein said control circuit is adapted to generate said feedback signal based on a detected level of the voltage on said internal voltage rail.

8. The power supply circuitry of claim 5, wherein said control circuit is adapted to generate the feedback signal based on a detected rate-of-change of the voltage on the internal rail.

9. The power supply circuitry of claim 4, wherein said control circuit is adapted to generate said feedback signal based on a detected level of the voltage on said supply voltage rail.

10. An integrated circuit comprising:
at least one islet comprising the power supply circuit of claim 1; and
a control unit adapted to selectively activate the power supply circuit of said at least one islet.

11. A method of controlling a power-up phase of an islet of an integrated circuit, the islet comprising a current-controlled switch coupled between a supply voltage rail and an internal voltage rail of said islet, the method comprising:
during said power-up phase, controlling said current-controlled switch to operate in a current-limited mode in which the current supplied by the switch is limited based on a reference current.

12. The method of claim 11, further comprising, at the end of said power-up phase, controlling said current-controlled switch to operate in a non-limited-current mode in which the current supplied by the switch is not limited based on said reference current.

13. The method of claim 12, wherein said current-controlled switch comprises a first transistor coupled by its main current nodes between said supply voltage rail and said internal voltage rail; and second and third transistors coupled in series by their main current nodes between said supply voltage rail and an input line for receiving said reference current, wherein control nodes of said first and second transistors are coupled to said input line, and a control node of said third transistor is adapted to receive a feedback signal, and wherein:
controlling said current-controlled switch to operate in said current-limited mode comprises driving said feedback signal to activate said third transistor; and
controlling said current-controlled switch to operate in non-limited-current mode comprises driving said feedback signal to deactivate said third transistor.

14. The method of claim 12, wherein controlling said current-controlled switch to operate in said non-limited-current mode comprises detecting, by a control circuit, when the voltage on said internal voltage rail reaches a set level.

15. The method of claim 12, wherein controlling said current-controlled switch to operate in said non-limited-current mode comprises detecting, by a control circuit, when the time derivative of the voltage on said internal voltage rail drops below a set level during the power-up phase.
